(19) United States
(12) Patent Application Publication
(10) Pub. No.: US 2023/0206199 A1
(43) Pub. Date: Jun. 29, 2023

(54) OWNERSHIP DATA MANAGEMENT SYSTEM AND METHOD

(71) Applicant: MIGHTY JAXX INTERNATIONAL PTE. LTD., Singapore (SG)

(72) Inventors: Shaun CHUA, Singapore (SG); Parag BHATNAGAR, Singapore (SG); Hian Soh CHEONG, Singapore (SG); Jackson AW, Singapore (SG)

(73) Assignee: MIGHTY JAXX INTERNATIONAL PTE. LTD., Singapore (SG)

(21) Appl. No.: 17/920,999

(22) PCT Filed: Apr. 24, 2020
(86) PCT No.: PCT/SG2020/050254

§ 371 Date: Oct. 24, 2022

(51) Int. Cl. G06Q 20/12; G06Q 20/38; G06Q 20/42; G06F 21/10

(52) U.S. Cl. CPC G06Q 20/1235; G06Q 20/3827; G06Q 20/42; G06F 21/10; G06F 2221/0713

(57) ABSTRACT

A method of managing ownership data of at least one product is disclosed. The method includes a centralized server receiving at least one ownership-related request relating to the at least one product, creating at least one ownership record corresponding to the at least one ownership related request on the centralized server, and sending a request to a distributed ledger network to store a datum associated with the at least one ownership record on the distributed ledger network. A system including the centralized server in data communication with the distributed ledger network is also disclosed.

### TECHNICAL FIELD

This invention relates to an ownership data management system and method. More particularly, this invention relates to an ownership data management system and method for use when trading in collectible items/products.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Collectible items/products have been known to be bought and sold. Such items can be expensive, making them a desirable target for counterfeiters. It is not easy for a collector/buyer to distinguish between an original item and a counterfeit one. There can thus be no peace of mind for the collector/buyer when dealing with such collectible items. This may deter some from buying such items. Thus, there is a need for ensuring the originality of the collectible items to create a drive in the market for such items.

Another problem associated with collectible item transactions is the need to verify the ownership of the collectible items, especially during the transfer of a collectible item from a seller to a buyer. Ownership history has been known to be stored in a computer database which can only be accessed with a proper PIN. However, even with such PIN access, those skilled in the art will know that computer database can be hacked, and ownership data stored thereon may be compromised.

To mitigate this problem, different solutions have been proposed. One such solution is disclosed in US 2019/0340623 to Rivkind et al. Rivkind discloses a system for verifying authenticity of products based on proof of ownership and transfer of ownership used in a supply chain application. The system includes a private distributed ledger connected to a public distributed ledger. Although such a system is secure, it can be costly to implement and maintain. It also typically takes a few minutes for a distributed ledger, even a private one, to confirm a transaction; this tends to dampen the user experience when using the system. Furthermore, users of such a system must be members of the private distributed ledger. Although this may suit supply chain members in a commercial setting, it places too much of a burden to casual collectors who trade items only occasionally in a secondary market. Casual collectors also tend to be less tech savvy and sophisticated.

There is therefore a need for a system which addresses, at least in part, one or more of the forgoing problems.

### SUMMARY

According to an aspect of the present disclosure, there is provided a method of managing ownership data of at least one product. The method includes a centralized server receiving at least one ownership-related request relating to the at least one product, creating at least one ownership record corresponding to the at least one ownership related request on the centralized server, and sending a request to a distributed ledger network to store a datum associated with the at least one ownership record on the distributed ledger network.

In some embodiments of the method, sending a request to a distributed ledger network includes sending the request to the distributed ledger network at regular intervals wherein the datum is associated with the at least one ownership record created in an interval and is sent by the centralized server to the distributed ledger network at the end of the interval.

In some embodiments of the method, regular intervals include twenty-four-hour intervals.

In some embodiments, the method further includes generating the datum based on the at least one ownership record created in the interval.

In some embodiments, the method further includes generating a hash for each of the at least one ownership record and the datum includes a Merkel root of the generated hashes.

In some embodiments, the method may further include storing the datum on the centralized server, obtaining a transaction hash from the distributed leger network for retrieving the datum stored on the distributed ledger network, and associating the transaction hash with the datum on the centralized server.

In some embodiments of the method, sending a request to a distributed ledger network includes sending the request to the distributed ledger network when the number of the at least one ownership record reaches a predetermined number.

In some embodiments of the method, the ownership related request includes one of an ownership registration request and an ownership transfer request.

In some embodiments of the method, the ownership related request is an ownership transfer request initiated by a seller, and the method further includes receiving an ownership transfer acceptance from a buyer by the centralized server prior to the centralized server sending the request to the distributed ledger network.

In some embodiments, the method further includes sending, by the centralized server to the buyer, a request for confirmation of the ownership transfer prior to receiving the ownership transfer acceptance from the buyer.

In some embodiments, the method further includes receiving payment from the buyer prior to receiving the ownership transfer acceptance from the buyer and releasing the payment to the seller after obtaining confirmation from the distributed ledger network that the at least one ownership record has been stored on the distributed ledger network.

In some embodiments, the method further includes obtaining a confirmation from the distributed ledger network, and sending, by the centralized server, to the seller at least one of a first confirmation prior to sending the request to the distributed ledger and a second confirmation after obtaining the confirmation from the distributed ledger network.

In some embodiments, the method further includes verifying originality of the at least one product by the centralized server prior to it receiving the at least one ownership-related request.

According to another aspect of the present disclosure, there is provided a system for managing ownership data of at least one product. The system includes a centralized server that is operable to receive at least one ownership-related request, create at least one ownership record corresponding to the at least one ownership related request thereon, and send a request to a distributed ledger network to store a datum associated with the at least one ownership record on the distributed ledger network.

In some embodiments, the system further includes a distributed ledger network that is in data communication with the centralized server. The distributed ledger network includes at least two nodes, and the distributed ledger network is operable to receive and process the request from the centralized server to store the datum on the distributed ledger network.

In some embodiments, the system further includes a plurality of user devices. Each of the plurality of user devices is operable to send the at least one ownership-related request to the centralized server.

According to another aspect of the present disclosure, there is provided a centralized server. The centralized server is operable to receive at least one ownership-related request from a user device, create at least one ownership record corresponding to the at least one ownership-related request thereon, and send a request to a distributed ledger network to store a datum associated with the at least one ownership record on the distributed ledger network.

In some embodiments, the centralized server sends the request to the distributed ledger network at regular intervals wherein the datum is associated with the at least one ownership record created in an interval and is sent to the distributed ledger network at the end of the interval.

In some embodiments of the centralized server, the regular intervals include twenty-four-hour intervals.

In some embodiments, the centralized server is further operable to generate the datum based on the at least one ownership record created in the interval.

In some embodiments of the centralized server, the ownership related request includes one of an ownership registration request and an ownership transfer request.

In some embodiments of the centralized server, the ownership related request is an ownership transfer request initiated by a seller, and the centralized server is further operable to receive an ownership transfer acceptance from a buyer prior to the centralized server sending the request to the distributed ledger network.

In some embodiments, the centralized server is further operable to send a request for confirmation of the ownership transfer to the buyer prior to receiving the ownership transfer acceptance from the buyer.

In some embodiments, the centralized server is further operable to verify originality of the at least one product prior to receiving the at least one ownership-related request.

According to another aspect of the present disclosure, there is provided a program storage device readable by a centralized server, tangibly embodying a program of instructions, executable by the centralized server to perform the method of managing ownership data of at least one product described above.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1 is a block diagram of a system for managing ownership data of a product according to an embodiment of the invention;

FIG. 2 is a ladder diagram showing a method of ownership registration in the system in FIG. 1;

FIG. 3 is a ladder diagram showing a method of ownership transfer in the system in FIG. 1;

FIG. 4 is a ladder diagram showing a method of proofing ownership in the system in FIG. 1;

FIG. 5 is a flow diagram showing ownership registration by a first collector and ownership transfer between the first collector and a second collector in the system in FIG. 1; and

FIG. 6 is a flow diagram showing a method of verifying the originality of a product in the system in FIG. 1 that may be optionally used in any one of the methods in FIGS. 2-5.

### DETAILED DESCRIPTION OF THE EMBODIMENTS

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

Unless defined otherwise, all technical and scientific terms used herein have the same meaning as is commonly understood by a skilled person to which the subject matter herein belongs.

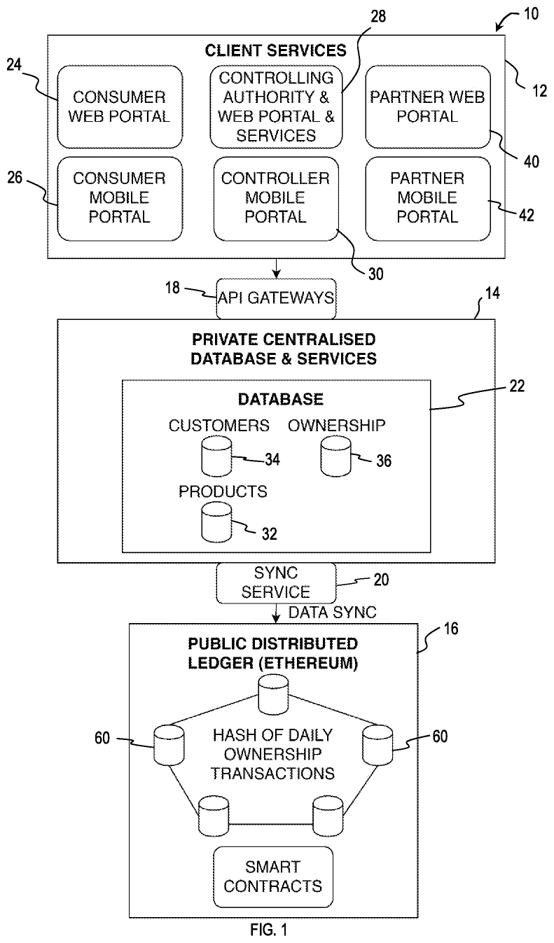

As shown in the drawings for purposes of illustration, the invention may be embodied in a novel, user-friendly, reasonably secure and trustworthy product ownership data management system. Existing systems tend to be either not tamper-proof or tamper-proof but diminishing the user experience when using the systems. Referring to FIG. 1, an ownership data management system embodying the invention generally includes a centralized server that is operable to receive at least one ownership-related request from a user device, create at least one ownership record corresponding to the at least one ownership related request thereon, and send a request to a distributed ledger network to store the at least one ownership record on the distributed ledger network.

Specifically, FIG. 1 shows a system 10 for managing ownership data related to collectible products, such as toys, antiques, art pieces, wines, etc. according to an embodiment of the invention. However, the system 10 may also be used for managing ownership data of products other than collectible products. The system 10 includes at least one user device 12, a centralized server 14 and a distributed ledger network 16. The centralized server 14 is data communicatively coupled, via the Internet (not shown), to the user device 12 and the distributed ledger network 16. The centralized server 14 is typically built around a single server 14 that handles all processing. The centralized server 14 is controlled by a single administrative entity, such as a collectible product business owner. It operates based on a client-server architecture. The centralized server 14 includes at least one processing unit/processor (not shown) and a program storage device (not shown) readable by the processing unit that tangibly embodies a program of instructions, executable by the processing unit to provide services of the centralized server 14.

The centralized server 14 includes an application programming interface (API) gateway 18, a sync service module 20 and a database 22. The centralized server 14 provides ownership-related data capturing services to the users of the system 10 via an App (not shown) running on user devices 12, such as mobile devices 12, of the users. The App is a software application that is downloaded and installed on the users' mobile devices 12. The App pulls content and data from the centralized server 14 through the Internet. In addition to the App, the users may also interact with the centralized server 14 via a collector web portal 24 and a collector mobile portal 26 supported by the centralized server 14. These portals are private locations on the Internet, accessible with unique URLs (web addresses) and unique usernames and passwords. However, the services may also be further provided via websites and mobile websites. Suitable graphical user interfaces (GUIs) are provided on the user devices 12 to enable the users to access the services of the centralized server 14. The collector web portal 24 therefore, is preferably accessible via a web browser on the user device 12 and provides a page on the world wide web, or another access point where a collector can engage with the system 10, for example for the collector to register ownership and transfer ownership of a collectible product. Similarly, the business owner also has a business owner web portal 28 and a business owner mobile portal 30 for writing data to and reading data from a product table 32, a customer table 34 and an ownership table 36 in the database 112, and for making requests, sending data, confirming data, and the like. In addition to the App, these portals are alternative/additional entry points into the system 10 that provide a location for creating and maintaining product and ownership-related data. Partners of the business owner may also access the centralized server 14 via partner web portals 40 and partner mobile portals 42 to provide value added contents associated with the products offered by the business owner.

As mentioned above, user devices 12, such as but not limited to mobile devices, laptops and personal computers with a suitable user interface are used to access the portals. Each user device 12 may include at least one processing unit and a form of memory. The API gateway 18 on the centralized server 14 allows communication between the user devices 12 and the services provided by the centralized server 14. An identity services module (not shown) manages an identity for each collector, business owner and partner that logs into the centralized server 14. The identity services module stores or validates data about the collectors, the business owner and the partners. This identity can be utilized to confirm and register a user, in certain applications of the system 10. Thus, to confirm identity, the identity services module can be utilized to confirm the data about the user prior to allowing the user to access services provided by the centralized server 14.

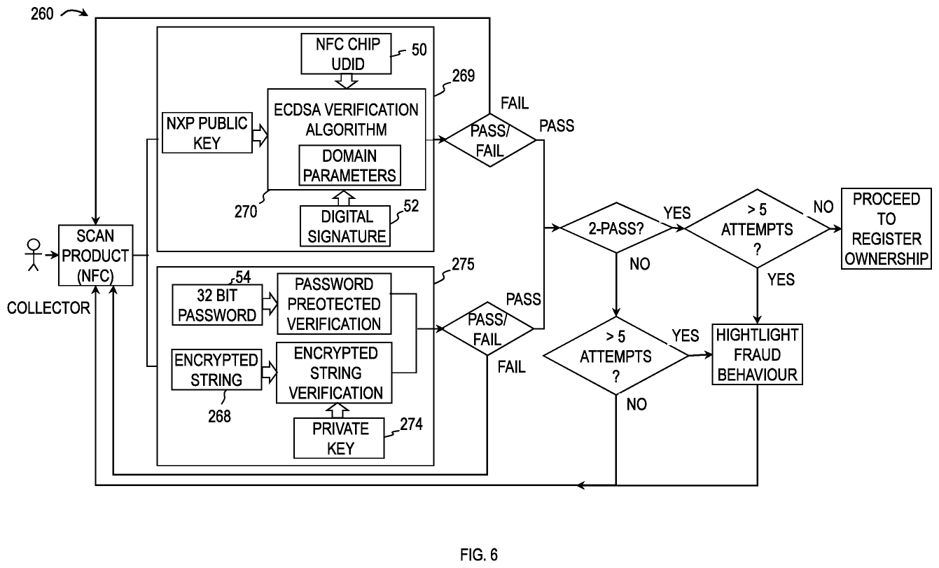

During use of the system 10, the business owner registers product information on the centralized server 14 via an App or a suitable portal. For example, the product information may include unique product IDs (PID) and detailed information about each product. This product information is stored in the product table 32 in the database 22 of the centralized server 14. For each original product, the business owner may request a unique product ID (PID) from the centralized server 14 for assigning to the product. The unique product ID (PID) is encrypted and stored in an electronic tag, such as but not limited to, a near field communication (NFC) chip (not shown). The NFC chip also carries an NFC chip unique identifier (UDID) 50 (FIG. 6), a digital signature 52 and a 32-bit password 54. Once the NFC chip is programmed with the unique product ID, the NFC chip is attached to or embedded in the original product. Instead of the business owner uploading a list of unique product IDs (PIDs) onto the centralized server 14, the centralized server 14 may generate the unique product IDs (PIDs) as described above. When no product has yet been sold, the ownership table 36 will be empty. Once the products are sold, the system 10 would allow ownership registration, query of ownership data and transfer of ownership. Therefore, the centralized server 14 allows for storage of product data, ownership data, and customer data in the database 22 thereof. The methods for ownership registration and ownership transfer will be described in more details later. For the time being, it is to be noted that ownership records (not shown) are created during ownership registration and ownership transfer and stored in the ownership table 36 in the database 22.

The centralized server 14 uploads a datum associated with ownership records created and stored thereon at regular intervals onto the distributed ledger network 16 using the sync service module 20. In other words, the centralized server 14 keeps track of ownership records created during an interval, generates a datum associated with these ownership records at the end of the interval and sends the generated datum to the distributed ledger network 16 for storage thereon such that a copy of the datum is maintained on the distributed ledger network 16. The intervals for sending these data may be twenty-four-hour intervals. However, the interval may also be shorter or longer than twenty-four hours. The datum is stored in a block on the distributed ledger network 104 maintained by nodes 60 of the distributed ledger network 16.

The distributed ledger network 16 can be based on any distributed ledger technology (DLT) implementation e.g. Ethereum, Quorum, Hyperledger, R3 Corda, or another private or public distributed ledger network 16. As is known to those skilled in the art, the distributed ledger network 16 includes a plurality of nodes 60 associated with different members of the network 16. This plurality of nodes 60 cooperate to provide the required data protection and trust. It allows the data to be stored and securely managed by the members without a central authority. Any attempt to falsify data on the distributed ledger network 16 will be detected and rejected by the members of the distributed ledger network 16, who independently validate and control the correct version of the data. In this manner, ownership records can be registered/stored (“notarized”) on every node 60 of the distributed ledger network 16 and this allows a seller to prove ownership of the product to a buyer.

The business owner and the users/collectors can examine the full history of ownership of a product using the centralized server 14. This provides a powerful and clear chain of title to a buyer who is interested in buying the product to be confident that he is trading in an original product and ultimately this gives collectors confidence in the originality and/or quality of the products.

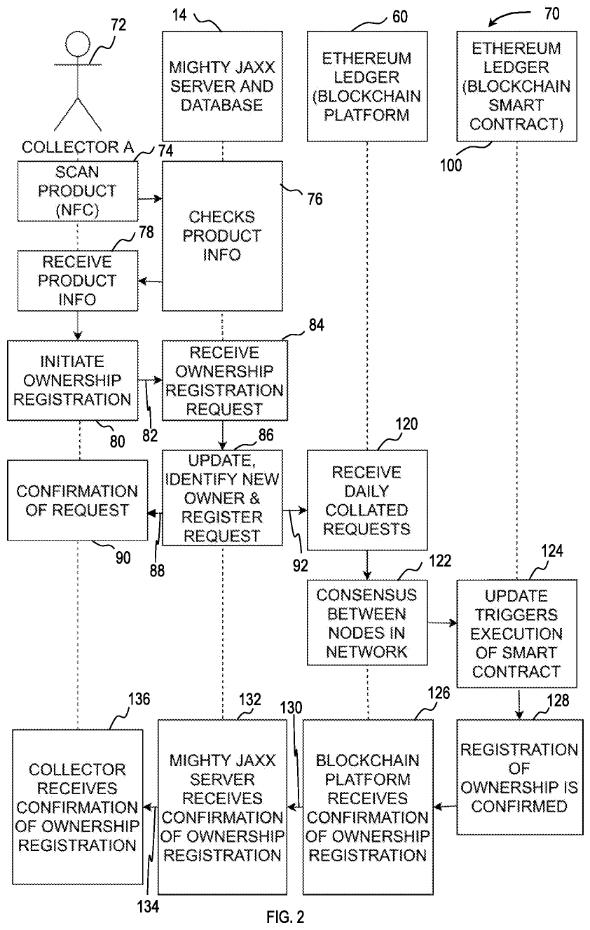

A method 70 of ownership registration using the system 10 is next described with the aid of FIG. 2. When a first collector (buyer) 72 purchases a product from the business owner, the buyer 72 may register ownership of the product with the system 10. The ownership registration method 70 starts in a SCAN PRODUCT step 74, wherein the buyer 72 runs the App on his mobile device 12. This step 74 allows the mobile device 12 to be used to scan the NFC chip of the purchased product to obtain at least the ID of the product (PID) stored on the NFC chip. The ownership registration method 70 next proceeds to a CHECK PRODUCT INFO step 76, wherein communication between the centralized server 14 and the mobile device 12 is established to allow the centralized server 102 to receive information about the NFC chip and verify the originality of the NFC chip, and thus, the originality of the product to which the NFC chip is permanently attached to or embedded in. The verification of originality in this CHECK PRODUCT INFO step 76 will be described in greater detail later. The method 70 ends in a RECEIVE PRODUCT INFO step 78 if the centralized server 14 is unable to verify that the NFC chip is original. In this step 78, the App will indicate to the buyer that the product may be counterfeit. However, if the centralized server 14 is able to verify that the NFC chip is original in the CHECK PRODUCT INFO step 76, the method 70 proceeds to the RECEIVE PRODUCT INFO step 78, wherein the App will indicate to the buyer 72 that the product is original. The method 70 next proceeds to an INITIATE OWNERSHIP REGISTRATION step 80, wherein the buyer 72 is allowed to actuate an appropriate icon on a screen of his mobile device 12 to initiate ownership registration with the system 10. In this step 80, the mobile device 12 sends an OWNERSHIP REGISTRATION REQUEST message 82 to the centralized server 14. The OWNERSHIP REGISTRATION REQUEST message 82 includes the PID and the buyer's collector identity (CID).

The method 70 further proceeds to a RECEIVE OWNERSHIP REGISTRATION REQUEST step 84, wherein the centralized server 14 receives and processes the OWNERSHIP REGISTRATION REQUEST message 82 from the buyer's 72 mobile device 12. The method 70 further proceeds to an UPDATE NEW OWNER step 86, wherein the centralized server 14, after determining that originality of the NFC chip had been verified earlier, creates an ownership record in the ownership table 36 of the database 22. This ownership record includes the PID and the CID in the OWNERSHIP REGISTRATION REQUEST message 82, and a status field that is set to TO-BE-UPLOADED. This status indicates that the particular record has yet to be uploaded onto the distributed ledger network 16. The ownership record may also, optionally, include other information, such as but not limited to, type/class of product, date and time of the ownership registration, etc.

In this manner, buyers 72 who purchased products from the business owner may each register ownership of the product they bought, and have respective ownership records created in the ownership table 36 in the database 22 of the centralized server 14. As mentioned above, each of these ownership records created in an interval would have a status field indicating that the records have yet to be uploaded onto the distributed ledger network 16. In this UPDATE NEW OWNER step 86, the centralized server 14 also sends a first OWNERSHIP REGISTRATION CONFIRMATION message 88 to the mobile device 12 to indicate to the buyer 72 that ownership registration on the centralized server 14 is confirmed. The mobile device 12 receives this OWNERSHIP REGISTRATION CONFIRMATION message 88 in a CONFIRMATION OF REQUEST step 90.

At the end of the interval, such as after twenty-four hours as described above, the centralized server 14 extracts all records with a status field of TO-BE-UPLOADED from the ownership table 36. The centralized server 14 generates a datum associated with these records and sends an UPLOAD REQUEST message 92 that includes the datum to a public address of a smart contract 100 of the distributed ledger network 16. The datum may be a Merkel root of a Merkel tree of hashes. Each ownership record is cryptographically hashed to obtain a first hash value for the record. Next pairs of first hash values are cryptographically hashed to obtain a second hash value for each pair of first hash values so that the number of second hash values is half that of the first hash values. The process is repeated with the second hash values to obtain third hash values. At the end of such a process, there will be a single final hash value which is known as the Merkel root or root hash. Hashing of an ownership record is applying a function that maps the data of the ownership record to a fixed length output. A hashing algorithm in the function is applied to the input data and the resulting fixed length output is the hash. Many hashing algorithms are available; examples of which include but are not limited to the SHA-1, SHA-2, SHA-3, SHA-256, MD5, RIPEMD-160, bcrypt, Whirlpool, Blake2, Blake3 algorithms. The resulting hash is completely unique to the input data and the function itself is deterministic. By obtaining a Merkel root for all the ownership records created in a twenty-four hour period, huge amounts of data can be identified solely through the Merkel root. The use of the Merkel root creates vast storage savings and help to increase efficiency. The Merkel root or root hash can be used as a fingerprint for all the ownership records created in the twenty-four hour period. As long as the Merkel root is publicly known and trusted, it is possible to use it to prove integrity of the ownership records.

Other methods of obtaining the datum are also possible. These includes, but are not limited to, checksums and CRCs obtained based on the ownership records.

The centralized server 14 associates each ownership record with the final hash value and sends this final hash value in the UPLOAD REQUEST message 92 to the distributed ledger network 16 for storing the final hash value in a block of the distributed ledger network 16. The method 70 next proceeds to a RECEIVE DATUM step 120 wherein the UPLOAD REQUEST message 92 is received by a node 60 in the distributed ledger network 16 to thereby hit that node 60 as a blockchain transaction request. The node 60 registers and propagates the blockchain transaction request to other nodes 60 of the distributed ledger network 16. The transaction is processed by every node 60 independently. The final state (datum update) is validated and synchronized with a consensus protocol in a CONSENSUS BETWEEN NODES IN NETWORK step 122. The consensus protocol is used to validate and synchronize the data (the state) between the nodes 60; it makes sure all nodes 60 are in sync. The distributed ledger network 16 may use different kinds of consensus protocols as is known to those skilled in the art. A consensus simply means that all nodes 60 compare data and each agrees with the data regarding that transaction. Transaction processing also triggers the execution of the smart contract 100 in an UPDATE TRIGGERS EXECUTION OF SMART CONTRACT step 124, wherein members of the network 16 sign off the transaction. The method 70 next proceeds to a BLOCKCHAIN PLATFORM RECEIVES CONFIRMATION OF OWNERSHIP REGISTRATION step 126 via a REGISTRATION OF OWNERSHIP IS CONFIRMED step 128, wherein the distributed ledger network 16 prepares a block ID (transaction hash) of the block in the distributed ledger network 16 in which the hash value is stored.

After the UPDATE NEW OWNER step 86, the centralized server 14 checks regularly with the distributed ledger network 16 for the availability of the block ID (transaction hash). The method 70 next proceeds to a SERVER OBTAINS CONFIRMATION step 132 at the centralized server 14, wherein upon obtaining of the confirmation message 130 from the distributed ledger network 16, the centralized server 14 changes the status of the records marked TO-BE-UPLOADED to UPLOADED to indicate the completion of the uploading of the hash value associated with the records created in the interval. The centralized server 14 also links each of these records or the hash value stored thereon to the block ID (transaction hash) obtained from the distributed ledger network 16. The centralized server 14 sends a second confirmation message 134 to the mobile device 12. The method 70 finally ends in a COLLECTOR RECEIVES CONFIRMATION step 136 at the mobile device 12, wherein the mobile device 12 obtains a confirmation that the ownership registration is finally completed at the distributed ledger network 16, and proof of ownership or transfer of ownership can be carried out next by the buyer 72 as a rightful owner of the product.

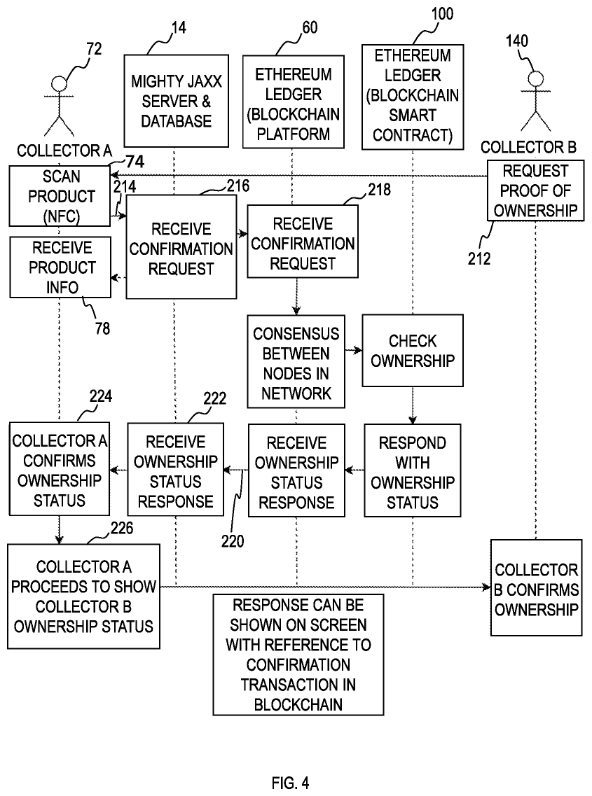

After the buyer 72 has registered ownership of the product with the system 10 as described above, the buyer 72 becomes the owner of the product. The owner 72 may now decide to sell the product to another buyer 140 (FIG. 4) via some online platforms such as Ebay etc. Such a sale will require the ownership data in the system 10 to be updated to reflect the transfer of ownership from the owner 72 to the new buyer 140.

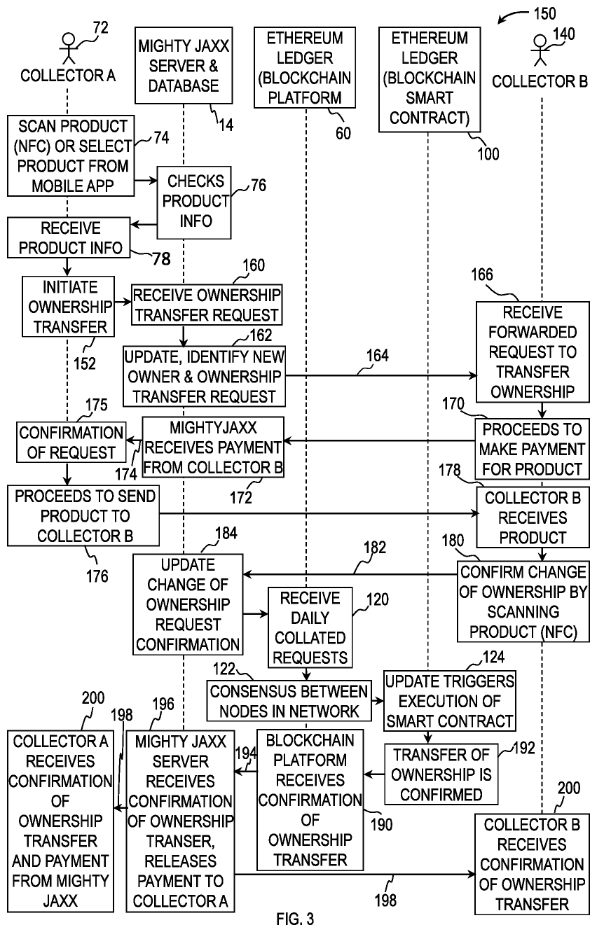

A method 150 of ownership transfer according to an embodiment of the invention is next described with the aid of FIG. 3. The ownership transfer method 150 starts in the SCAN PRODUCT step 74, wherein the owner 72 runs the App on his mobile device 12. This step 74 allows the mobile device 12 to be used to scan the NFC chip of the product he purchased to obtain an ID of the product (PID). The ownership transfer method 150 further proceeds to the CHECK PRODUCT INFO step 76, wherein communication between the centralized server 14 and the mobile device 12 is established to allow the centralized server 14 to receive information of the NFC chip and verify the originality of the NFC chip, and thus, the originality of the product to which the NFC chip is permanently attached to or embedded in. This verification of originality in the CHECK PRODUCT INFO step 76 will be described in greater detail later. The method 150 ends in the RECEIVE PRODUCT INFO step 78 if the centralized server 14 is unable to verify that the NFC chip is original. In this step 78, the App will indicate to the buyer that the product may be counterfeit. However, if the centralized server 14 is able to verify that the NFC chip is original in the CHECK PRODUCT INFO step 76, the method 150 proceeds to an INITIATE OWNERSHIP TRANSFER step 152, wherein the owner 72 is allowed to actuate an appropriate icon on a screen of his mobile device 12 to initiate ownership transfer. In this step 152, the mobile device 12 sends an OWNERSHIP TRANSFER REQUEST message 154 to the centralized server 14. The OWNERSHIP TRANSFER REQUEST message 154 includes the PID of the product and CID of the new buyer 140. The method 150 further proceeds to a RECEIVE OWNERSHIP TRANSFER step 160 wherein the centralized server 14 receives and processes the OWNERSHIP TRANSFER REQUEST message 154 from the owner's 72 mobile device 12. The method 150 further proceeds to an UPDATE NEW OWNER step 162, wherein the centralized server 14, after determining that originality of the NFC chip had been verified earlier in the CHECK PRODUCT INFO step 76, creates another ownership record in the ownership table 36 of the database 22.

The centralized server 14 updates the status of this ownership record as WAITING FOR CONFIRMATION and sends a CONFIRMATION REQUEST message 164 to the new buyer 140. The method 150 next proceeds to a RECEIVE REQUEST TO TRANSFER OWNERSHIP step 166 at a mobile device 12 of the new buyer 140. In this step 166, the new buyer 140 is notified that the owner 72 of the product has initiated transfer of ownership of the product to the new buyer 140 and requires him to make a payment and to accept the transfer.

The method 150 next proceeds to a MAKE PAYMENT step 170, wherein the new buyer 140 makes an electronic payment to the centralized server 14. The centralized server 14 receives this payment in a RECEIVE PAYMENT step 172, and sends a first confirmation message 174 to the owner 72. The owner 72 receives the first confirmation message 174 in a CONFIRMATION OF REQUEST step 175 to be informed that payment has been made by the new buyer 140 that is held at the centralized server 14. The owner 72 then sends the product, via courier or post, to the new buyer 140 in a SEND PRODUCT step 176. When the new buyer receives the product in a RECEIVE PRODUCT step 178, the new buyer 140 uses the App in his mobile device 12 to scan the NFC chip in the received product to retrieve the PID of the product for verification of the originality of the product as described above. Once it is verified that the product is original, the new buyer 140 is allowed by the centralized server 14 to accept the transfer of ownership in a CONFIM CHANGE OF OWNERSHIP step 180 at the mobile device 12. The new buyer 140 accepts the transfer of ownership by actuating an appropriate icon in the App to send a CONFIRMATION ACCEPTED message 182 to the centralized server 14. This CONFIRMATION ACCEPTED message 182 includes the PID of the received product and the CID of the new buyer 140. The method 150 next proceeds to an UPDATE CHANGE OF OWNERSHIP step 184 in the centralized server 14, wherein the centralized server 14 retrieves the newly created record based on the PID and updates it with the CID of the new buyer 140. The centralized server 14 further changes the status of the record from WAITING FOR CONFIRMATION to TO-BE-UPLOADED so that at the end of the current interval, this record and other similarly marked records can be retrieved for a datum to be generated therefrom and uploaded to the distributed ledger network 104.

The ownership record for this ownership transfer transaction has exactly the same fields as that of the ownership record described in the ownership registration method 70 described above. However, the ownership record created during an ownership transfer may be of a different format than that used in ownership registration.

At the end of the interval, the centralized server 14 extracts all records in the ownership table 36 with a status of TO-BE-UPLOADED. The centralized server 14 generates a datum associated with these records, associates each of these ownership records with the datum and sends an UPLOAD REQUEST message 92 that includes the datum to a public address of the smart contract 100 of the distributed ledger network 16. As described above in relation to ownership registration, the centralized server 14 obtains a single hash value as the datum based on all the records and sends this single hash value to the network 16 for storing in a block thereof. The UPLOAD REQUEST message 92 is received by a node 60 of the network 16 in the RECEIVE DATUM step 120 to thereby hit that node 60 as a blockchain transaction request. The node 60 registers and propagates the blockchain transaction request to other nodes 60 of the distributed ledger network 16. The transaction is processed by every node 60 independently. The final state (datum update) is validated and synchronized with a consensus protocol in the CONSENSUS BETWEEN NODES IN NETWORK step 122. Transaction processing also triggers the execution of the smart contract 100 in the UPDATE TRIGGERS EXECUTION OF SMART CONTRACT step 124, wherein members of the network 16 sign off the transaction. The method 150 next proceeds to the BLOCKCHAIN PLATFORM RECEIVES CONFIRMATION OF OWNERSHIP TRANSFER step 190 via the TRANSFER OF OWNERSHIP IS CONFIRMED step 192 wherein the distributed ledger network 16 prepares a block ID (transaction hash) of the block in the distributed ledger network 16 in which the hash value is stored.

After the UPDATE CHANGE OF OWNERSHIP step 184, the centralized server 14 checks regularly with the distributed ledger network 16 for the availability of the block ID (transaction hash). The method 150 next proceeds to a SERVER OBTAINS CONFIRMATION step 196 at the centralized server 14, wherein upon obtaining of the confirmation message 194 from the distributed ledger network 16, the centralized server 14 changes the status of the records marked TO-BE-UPLOADED to UPLOADED-COMPLETED to indicate the completion of the uploading of the hash value associated with the records created in the interval. The centralized server 14 also links each of these records or the hash value stored thereon to the block ID (transaction hash) obtained from the distributed ledger network 16. The centralized server 14 sends an OWNERSHIP TRANSFER CONFIRMATION message 198 to both the owner's mobile device 12 the new buyer's mobile device 12. The method 150 finally ends in a respective COLLECTOR RECEIVES CONFIRMATION step 200 at the mobile devices 12 of the owner 72 and the new buyer 140, wherein the mobile devices 12 obtain a confirmation from the system 10 that the ownership transfer between the owner 72 and the new buyer 140 has been completed. The centralized server 14 also releases payment it received earlier from the buyer 140 to the owner 72.

It is possible before the new buyer 140 agrees to buy the product from the owner 72 of the product, the new buyer 140 may request that the owner prove that he is the rightful owner of the product. A method 210 of proving ownership 210 is next described with the aid of FIG. 4. In the method 210, the new buyer 140 requests the owner 72 to prove ownership in a REQUEST FOR PROOF step 212. The owner 72 scans the NFC chip of the product in the SCAN PRODUCT step 74 as described above. The owner 72 then actuates an appropriate icon on his mobile device 12 to send an OWNERSHIP DATA VERIFICATION message 214 to the centralized server 14. This message 214 includes the PID of the product and the CID of the owner 72. The centralized server 14 upon receiving this OWNERSHIP DATA VERIFICATION message 214 in a RECEIVE VERIFICATION REQUEST step 216 extracts the latest ownership record associated with the PID and compares the CID stored therein with that received. If the two CIDs match, the centralized server 14 obtains the block ID (transaction hash) associated with the record or hash value and forwards the block ID (transaction hash) to the distributed ledger network 16. Upon receiving the OWNERSHIP DATA VERIFICATION message 214 in a RECEIVE VERIFICATION REQUEST step 218, the distributed ledger network 16 retrieves the datum/hash value based on the block ID (transaction hash). The distributed ledger network 16 next returns the datum/hash value to the centralized server 14 in an OWNERSHIP DATA RESPONSE message 220. The centralized server 14 then sends a result of the CID comparison, the hash value stored thereon and the hash value stored on and obtained from the distributed ledger network to the owner's mobile device 12 in a RECEIVE OWNERSHIP STATUS RESPONSE step 222. The owner 72 upon receiving this OWNERSHIP DATA RESPONSE message 220 in a COLLECTOR CONFIRMS OWNERSHIP step 224 can then present the result to the new buyer 140 to prove his ownership in a SHOW OWNERSHIP STATUS step 226. With two matching hash values, one from the centralized server 14 and one from the trusted distributed ledger network 16, confidence in the ownership information returned by the centralized server 14 will be enhanced.

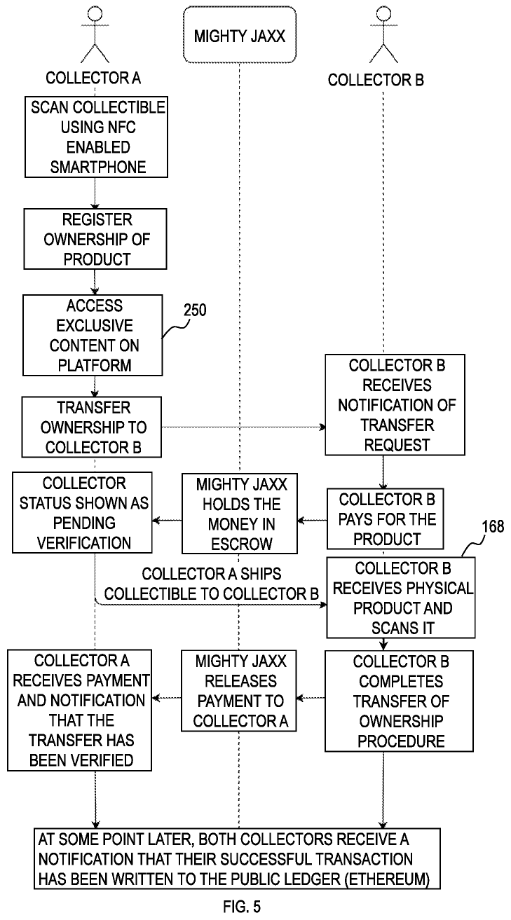

FIG. 5 is a drawing showing the change of ownership of a product from the business owner to a collector A and finally to a collector B. After collector A purchases the product and has registered ownership 70 with the system 10 as described above, collector A is given access 250 to exclusive content by the system 10. This exclusive content includes, but is not limited to, videos, fan engagement, greetings from favorite artists who designed the products, etc. as a value added service provided by the business owner.

FIG. 6 shows a method 260 of verifying originality of a product as carried out in the CHECK PRODUCT INFO step 76. As described above, when the user uses the App to scan the NFC chip of the product, the mobile device 12 obtains a 32-bit password 54 from the centralized server 14 and sends this 32-bit password 54 to the NFC chip. The NFC chip verifies that the 32-bit password 54 received from the mobile device 12 matches that stored in the NFC chip. The NFC chip next returns to the mobile device 12 an NFC chip unique ID (UDID) 50, a digital signature 52 and an encrypted string 268 containing a product ID (PID). The mobile device 12 forwards these three pieces of information to the centralized server 14. In a first test 269, the centralized server 14 verifies the NFC chip UDID 50 and the digital signature 52 in a verification algorithm 270 using a public key 272 provided by the manufacturer of the NFC chip.

The centralized server 14 also decrypts the encrypted string 268 received from the NFC chip using a private key 274. In a second test 275, the PID obtained from the decrypted string is compared to those stored in the product table 32 of the database 22. The centralized server 14 will determine that the product is original if the information returned from the NFC chip passes both the first test 269 and the second test 275 in less than a predetermined number of attempts.

If the information fails either of the two tests 269, 275 in an attempt, the process of obtaining the information and verification is repeated and the number of attempts is counted. If the number of attempts exceeds the predetermined number of attempts, the centralized server 14 will indicate that the product may be counterfeit and/or there may be a fraudulent activity and forbid the user from proceeding further. On the other hand, if the centralized server 14 determines that the information is verified in less than the predetermined number of attempts, the centralized server 14 will allow the user to proceed with ownership registration, ownership transfer, ownership acceptance, etc. as described above.

Advantageously, the ownership data management system 100 improves the user experience by providing a timely response to an ownership registration or ownership transfer request through the introduction of the centralized server 14. Since management of private and public keys are handled by the business owner, casual collectors will find the system less cumbersome and more user friendly. At the same time, since the ownership records are also uploaded onto a distributed ledger network 16 to be in sync with those stored on the centralized server 14, the ownership records is made more secure and tamper-resistant. And together with the use of the electronic tag, the system 10 therefore gives the collectors the consumer confidence that products are original and assurance that they are dealing with true owners of the products. Furthermore, with bulk uploads to the distributed ledger network 16 that charges per transaction carried out only once in an interval, the running cost of the system 10 is reduced significantly for the business owner.

Although the present invention is described as implemented in the above described embodiments, it is not to be construed to be limited as such. For example, although it is described that a datum that is associated with ownership records created in an interval is sent to the distributed ledger network 16 at the end of the interval to be uploaded/stored thereon, a datum for each ownership record may be sent to the distributed ledger network 16 as and when the ownership record is created by the centralized server 14.

As another example, it is described that the centralized server 14 checks regularly with the distributed ledger network 16 for the availability of the block ID (transaction hash). The distributed ledger network 16 may however be configured to send the block ID (transaction hash) to the centralized server once the block ID (transaction hash) is available. In such a case, obtaining the block ID (transaction hash) by the centralized server 14 is merely receiving it from the distributed ledger network 16.

As another example, instead of sending a datum that is associated with ownership records created in an interval to the distributed ledger network 16, the centralized server 14 may send a datum associated with ownership records to the distributed ledger network 16 when the number of yet to be uploaded ownership records in the centralized server 14 reaches a predetermined number.

As yet a further example, it is described that the centralized server 14 sends a CONFIRMATION REQUEST message 164 to the new buyer 140, such a message 164 may be sent outside of the system 10 to the new buyer 140 by the owner 72. For example, the message 164 may be sent as a short message from the owner's mobile device 12 to the new buyer's mobile device 12.

It should be further appreciated by the person skilled in the art that one or more of the above modifications or improvements, not being mutually exclusive, may be further combined to form yet further embodiments of the present invention.

1. A method of managing ownership data of at least one product, the method comprising:
receiving at least one ownership-related request relating to the at least one product by a centralized server;
creating at least one ownership record corresponding to the at least one ownership related request on the centralized server; and
sending a request by the centralized server to a distributed ledger network to store a datum associated with the at least one ownership record on the distributed ledger network.

2. The method of managing ownership data according to claim 1, wherein sending a request to a distributed ledger network comprises sending the request to the distributed ledger network at regular intervals wherein the datum associated with the at least one ownership record created in an interval is sent by the centralized server to the distributed ledger network at the end of the interval.

3. The method of managing ownership data according to claim 2, wherein the regular intervals comprise twenty-four-hour intervals.

4. The method of managing ownership data according to claim 2, further comprising generating the datum based on the at least one ownership record created in the interval.

5. The method of managing ownership data according to claim 4, further comprising generating a hash for each of the at least one ownership record and the datum comprises a Merkel root of the generated hashes.

6. The method of managing ownership data according to claim 5, further comprising
storing the datum on the centralized server;
obtaining a transaction hash from the distributed ledger network for retrieving the datum stored thereon; and
associating the transaction hash with the datum on the centralized server.

7. The method of managing ownership data according to claim 1, wherein sending a request to a distributed ledger network comprises sending the request to the distributed ledger network when the at least one ownership record reaches a predetermined number of ownership records.

8. The method of managing ownership data according to claim 1, wherein the ownership related request comprises one of an ownership registration request and an ownership transfer request.

9. The method of managing ownership data according to claim 1, wherein the ownership related request is an ownership transfer request initiated by a seller, and the method further comprises receiving an ownership transfer acceptance from a buyer by the centralized server prior to the centralized server sending the request to the distributed ledger network.

10. The method of managing ownership data according to claim 9, further comprising sending, by the centralized server to the buyer, a request for confirmation of the ownership transfer prior to receiving the ownership transfer acceptance from the buyer.

11. The method of managing ownership data according to claim 10, further comprising receiving payment from the buyer prior to receiving the ownership transfer acceptance from the buyer and releasing the payment to the seller after obtaining confirmation from the distributed ledger network that the at least one ownership record has been stored on the distributed ledger network.

12. The method of managing ownership data according to claim 1, further comprising:
obtaining a confirmation from the distributed ledger network; and
sending, by the centralized server, to the seller at least one of a first confirmation prior to sending the request to the distributed ledger and a second confirmation after obtaining the confirmation from the distributed ledger network.

13. The method of managing ownership data according to claim 1, further comprising:
verifying originality of the at least one product by the centralized server prior to receiving the at least one ownership-related request.

14. A system for managing ownership data of at least one product, comprising:
a centralized server that is operable to:
receive at least one ownership-related request;
create at least one ownership record corresponding to the at least one ownership related request thereon; and
send a request to a distributed ledger network to store a datum associated with the at least one ownership record on the distributed ledger network.

15. The system according to claim 14, further comprising:
a distributed ledger network in data communication with the centralized server, the distributed ledger network comprising at least two nodes, the distributed ledger network operable to:
receive and process the request from the centralized server to store the datum on the distributed ledger network.

16. The system according to claim 14, further comprising:
a plurality of user devices, each of which is operable to:
send the at least one ownership-related request to the centralized server.

17. (canceled)

18. The system according to claim 14, wherein the centralized server sends the request to the distributed ledger network at regular intervals wherein the datum associated with the at least one ownership record created in an interval is sent to the distributed ledger network at the end of the interval.

19. The system according to claim 18, wherein the regular intervals comprise twenty-four-hour intervals.

20. The system according to claim 19, further operable to generate the datum based on the at least one ownership record created in the interval.

21. (canceled)

22. (canceled)

23. (canceled)

24. (canceled)

25. A program storage device readable by a centralized server, tangibly embodying a program of instructions, executable by the centralized server to perform a method of managing ownership data of at least one product, the method comprising:
receiving at least one ownership-related request relating to the at least one product by the centralized server;
creating at least one ownership record corresponding to the at least one ownership related request on the centralized server; and
sending a request by the centralized server to a distributed ledger network to store a datum associated with the at least one ownership record on the distributed ledger network.
